(19) United States
(12) Patent Application Publication
(10) Pub. No.: US 2011/0219891 A1
(43) Pub. Date: Sep. 15, 2011

(54) Container For Fluid Sampling With Flexible Metal Alloy Walls

(75) Inventors: Gueorgui Mihaylov, Virginia Beach, VA (US); Bryan Truex, Belleair Beach, FL (US)

(73) Assignee: Nextteq, LLC, Tampa, FL (US)

(21) Appl. No.: 13/035,163

(22) Filed: Feb. 25, 2011

Related U.S. Application Data
(60) Provisional application No. 61/308,502, filed on Feb. 26, 2010.

(51) Int. Cl. G01N 1/12; B21D 51/26

(52) U.S. Cl. 73/864.64; 73/864.51; 413/1

(57) ABSTRACT

The present invention is directed to containers for fluids. The containers may comprise a flexible wall, wherein the flexible wall comprises a metal alloy. The metal alloy may be any metal alloy that may be formed into a sheet including, but not limited to, some stainless steel alloys such as SST 304, SST 309, SST 316, SST 316L, SST 321, low carbon stainless steels and nickel-titanium alloys known as Nitinol.

### RELATED APPLICATION

This patent applications claims priority under 35 U.S.C. §119 to U.S. Provisional Patent Application Ser. No. 61/308,502 filed on Feb. 26, 2010 which is incorporated by reference in its entirety.

### FIELD OF THE INVENTION

The present invention is directed to containers for fluids. In specific embodiments, the containers may comprise a flexible wall, wherein the flexible wall comprises a metal alloy.

### BACKGROUND OF THE INVENTION

Containers with fixed volumes such as, but not limited to, bottles and canisters or changeable volumes such as, but not limited to, flexible walled bags are used to prepare mixtures of gases for laboratory use or sampling of gases or liquids.

Such containers may be used in industrial hygiene and safety sampling to determine the concentration of gases in the environment or in processing equipment. In order to ensure accuracy and reliability, containers for sampling and/or containing gaseous and liquid substances have been specialized for particular uses. The containers may be substantially gas impermeable (at least for the target compounds), strong and resilient, have substantially inert inner wall surfaces so, in some applications, the fluid mixtures or samples may be able to be stored for extended periods of time without a significant change in composition of the sampled or prepared mixtures.

Fixed volume canisters may have walls made of a metal such as a stainless steel alloy, for example. The internal surface of wall may be additionally treated to reduce adsorption of compounds or contamination of the contents, for example, by being chemically polished and passivated. Disadvantages of fixed volume containers include high price, relatively high weight, bulkiness, and high transportation costs. Another disadvantage of fixed volume containers comes from their required maintenance and special preparation procedures including purging with noble gases prior to use, heating and then vacuuming to very low pressure with strong laboratory pumps to evacuate previous fluids.

The handling of samples is also difficult with fixed volume containers. Removal of a sample from a fixed volume container results in a reduced pressure or, in some cases, a partial vacuum inside the canister. In certain applications, additional carrier fluid must be added to compensate for the removed sample and then the sample concentration must be recalculated for accurate future uses.

Gas mixtures stored under pressure in fixed volume containers are used to make standard fluid mixtures in industrial quantities. Standard fluid mixtures typically comprise a comparably high concentration of one (or more) component in a carrier fluid. For laboratory use in calibrating analytical equipment, for example, such standards may be diluted with additional carrier fluid to obtain the appropriate concentration for particular application.

Due to the disadvantages of fixed volume containers, the most widely used containers for transporting, preserving and containing mixtures for laboratory or industrial hygiene use are containers comprising flexible walls. Typically, the flexible walls are made from an inert, low-permeable material. The walls should have low sorption on the walls for the contained and/or target components. Containers with flexible, low-permeable, low adsorbing walls, for example, sampling bags, are used widely for fluid sampling, air sampling and liquid sampling. Sampling bags have walls typically comprising materials such as Kynar (Hexafluoropropylene-polyviniliden fluoride) and Tedlar (modified polyvinyl fluoride polymer), for example.

In order to fill any of such containers with samples or mixtures, some preparation is needed. The bags should to be purged then flushed for desorption of any residues of previous contents and their volume should be reduced to as small as practical, preferably substantially zero. Any adsorbed residue or remaining contents can influence or contaminate the future fluid mixture or sampled fluid.

Plastic materials used for making sampling bags have low yet measurable permeation and the manufacturers usually publish data including permeability of sampling bags of different wall composition. The permeability data is provided with respect to different fluids, mixtures and gas samples over a certain time period and may be determined experimentally. There are at least two processes taking place in a sampling bag that affect the concentration of a component when the fluid is in contact with the inside walls of the bag including sorption on the walls and diffusion through the walls of the sampling bag. For some low concentration samples, despite claim of low sorption, the recovery of sampled material may be only 85-90% for the sampled component even shortly after the bag is loaded. These losses are primarily due to absorption on the walls and permeation through the plastic walls. Though walls may be cleaned or new, a portion of the available sorption sites are still active on the bag walls.

To control the losses through gas permeation, different materials are used for different sampled substances. Even materials like Teflon and other fluorinated plastics have some measurable gas permeability.

Permeability may be reduced by using sampling bags with walls comprising layers of different materials. Some multilayer sampling bags include aluminum foil sandwiched between polyolefin and polyester layers. Such bags have shown significantly decreased, yet still measurable, permeability for certain target compounds. To achieve good multilayer assembly and adherence, certain layers may comprise low melting point polymers such as polyethylene. However, polyethylene may emit low concentrations of residual monomers which contaminate the sampled volume. The sampling industry accepts and compensates for this lack of time stability of samples and sample contamination within sampling bags because the use of sampling bags is many times easier and less expensive compared to sampling with more stable fixed volume containers. All sampling with flexible wall sampling bags is currently performed with a sampling pump.

There is a need for a sampling container which will have all convenience of a sampling bag and the stability of sampling with hard wall canisters.

There is also a need for a sampling container allowing direct grab sampling by the operator without use of a mechanical pump.

Further, there is a need for a convenient container which will allow self sampling over short or extended periods of times.

Still further, there is a need for a multifunctional sampling fixture—sampling head that is easily operable such as, for example, by one hand, having not only On/Off functions, and allowing fast switch to different sampling modes such as different nozzle for intake of fluid sample into the bag tough through a series of aerodynamic resistances; sampling from the bag content directly or via on-the-valve septum; and fast fluid connection of the bag content to other fluid analyzing system.

### SUMMARY OF THE INVENTION

The invention is directed to embodiments of containers with flexible walls and methods of forming such containers. Embodiments include a sampling bag comprising at least one flexible wall, wherein the flexible wall comprises at least one layer comprising a metal alloy. Embodiments further include an inlet. The inlet may comprise at least one of an on/off valve, a flow control valve, tubing, a septum, a tubing connector, a flow restrictor, tubing connected to a pump, or other device desired to obtain a sample or deliver a fluid. An embodiment of the valve may comprise a quick disconnect connector and/or multiple inlets comprising shaped orifices resulting in different flow characteristics under identical flow conditions. The quick disconnect connector may be used to attach various different attachments to the valve.

The flexible wall may comprise at least one layer comprising a metal alloy sheet. In some embodiments, the flexible wall may consist of the metal alloy sheet. In other embodiments, the flexible wall may consist essentially of metal alloy sheet. Other embodiments of the sampling bag or container with flexible walls may have additional layers or other components.

Embodiments of the containers and sampling bags include a metal alloy sheet that forms substantially the entire inner surface of the sampling bag. In such embodiments, there may be other materials on the inner surface such as, but not limited to, sealing materials around the periphery of the bag or around any inlets or other apertures in the walls.

In a more specific embodiment, the sampling bag comprises two flexible walls that are joined to form the sampling bag. The flexible walls may be hermetically sealed at a periphery of the inner volume to form the sampling bag.

Any metal alloy sheet may be used that provides sufficient flexibility, and impermeability to the sampled gas. For example, the metal alloy sheet may have a thickness within the range of 10 to 100 microns, or within the range of 25 to 50 microns to facilitate folding.

Embodiments of the invention are also directed to methods of forming a container or sampling bag. An embodiment of the method of forming a sampling bag comprises sealing the perimeter of at least two sheets of corrosive resistant metal alloy sheets to form the sampling bag and providing an inlet to access to the space between the two sheets. The sheets may be sealed by any method including, but not limited to, welding two sheets, laser welding the two sheets, gluing the two sheets, folding and crimping the sheets with a gasket, for example. After sealing, the perimeter of the sheets may comprise a seam; the seam may be from 0.5 to 1.5 mm wide.

An inlet to the space between the sealed sheets may be provided by forming an aperture in at least one of the metal alloy sheets. The aperture may be formed by punching an aperture, cutting an aperture, or laser cutting an aperture, for example. The method of forming the sample bag may further comprise mounting a valve in the aperture. The aperture may be sealed by mounting the valve using gaskets.

Embodiments of the method of forming a sampling bag may further comprise passivating the space between the two sheets. Passivating the space between the two sheets may comprise adding an acid to the sampling bag. The acid may be nitric acid or citric acid, for example, and in any concentration effective to passivate the surface of the metal alloy, such as, but not limited to a concentration of the acid in the range of from 3% to 5%. After passivation, the interior of the bag may be dried. The drying of the interior of the bag may comprise heating the bag to a temperature above 60° C. and while applying a vacuum through the aperture to the interior of the bag, for example; other drying methods may be used also. Chemical passivating of at least one inner surface on each of the sheets prior to sealing the perimeter may be performed with an acid.

Another embodiment of the invention comprises a sampling bag with a quick opening sampling valve. The valve may comprise a base and a stem comprising a connector, wherein valve is open when a longitudinal axis of the stem is oriented parallel to a longitudinal axis of the base and the valve is closed when the longitudinal axis of the stem is oriented perpendicular to a longitudinal axis of the base. The sampling valve may further comprise a quick disconnect connector capable of receiving a plurality of sampling attachments. The sampling attachments may include, but are not limited to, a tube connector, a septum holder, or an inlet comprising a calibrated aerodynamic resistance, for example. The inlet comprising a calibrated aerodynamic resistance may be calibrated to at least partially fill the sampling bag in a time selected from 15 minutes, 30 minutes, one hour, two hours, four hours, eight hours, or twenty four hours based upon a typical differential pressure of the sampling bag with the environment to be sampled.

Another embodiment of the sampling valve may comprise a multipositional valve, wherein the multipositional valve comprises at least two inlets and a three position valve. Each of the inlets may comprise a different calibrated aerodynamic resistance flow path, wherein each of the inlets is calibrated for a different flow rate under identical conditions.

Further embodiments of the multipositional sampling valve may comprise three selectable inlets, wherein each of the inlets is calibrated for a different flow rate under identical conditions. For example, embodiments of the multipositional valve may comprise a rotatable turret for selectively opening the valve to one of the inlets or for closing the valve. The turret may be combined with a second valve, wherein the second valve is an on/off valve having two positions, wherein one position opens the valve and the second position closes the valve, wherein the second valve comprises a base and a stem, wherein the second valve is open when the longitudinal axis of the stem is oriented parallel to a longitudinal axis of the base and the valve is closed when the longitudinal axis of the stem is oriented perpendicular to a longitudinal axis of the base.

Some materials, typically considered to by very hard yet breakable (cold-short), may be manufactured by other methods into thin layers or sheets thus become flexible and conformable. For example, some stainless steel alloys such as SST 304, SST 309, SST 316, SST 316L, SST 321, low carbon stainless steels and nickel-titanium alloys known as Nitinol have become available in thin somewhat flexible sheets. Embodiments of the sampling bags of the invention may comprise walls comprising flexible stainless steel alloy sheets. Further embodiments of the sampling bags may comprise flexible nickel sheets or Titanium thin sheets.

The present invention is directed to the use of thin sheets stainless steel or other highly corrosion proof alloy for sampling bag walls. Further embodiments are directed to methods for sealing such sampling bags with walls comprising and treating the internal and external surfaces for different needs—sampling of different gases and mixtures. Bags from stainless steel or such alloys can be long lasting, easy cleanable and can be purged at elevated temperatures from any possible residue. Stainless steel or alloy bags can be much less expensive alternative to the canisters and much better alternative to the plastic sampling bags, avoiding already mentioned inherited disadvantages for both of them. On the other hand there is no experience or hint of manufacturing sampling bags from thin sheet metals coming from many technological restrictions of such craft.

The present invention is also directed to come with the designs of a sampling bag allowing sampling without pump—by using hand engaged side panels and/or by spring comprised the way to open the bag creating underpressure which will propel the sampled fluid inside.

The present invention is also directed to sampling bags comprising an inlet/outlet enclosure which allows On/Off functions, flow paths for short and/or long term sampling and a septum for sample withdrawal.

Other aspects and features of embodiments of the sampling bags comprising metal alloys will become apparent to those of ordinary skill in the art, upon reviewing the following description of specific, exemplary embodiments of the present invention in concert with the figures. While features may be discussed relative to certain embodiments and figures, all embodiments can include one or more of the features discussed herein. While one or more particular embodiments may be discussed herein as having certain advantageous features, each of such features may also be integrated into various other of the embodiments of the invention (except to the extent that such integration is incompatible with other features thereof) discussed herein. In similar fashion, while exemplary embodiments may be discussed below as system or method embodiments it is to be understood that such exemplary embodiments can be implemented in various systems and methods.

### BRIEF DESCRIPTION OF THE DRAWINGS

FIG. 1 depicts an embodiment of a sampling bag having two flexible walls comprising layers of thin sheets of metal alloys; FIG. 1a shows the sampling bag in a flattened state with substantially no internal volume and FIG. 1b shows the sampling bag in a filled or loaded state;

FIG. 2A depicts side wall and seams cross sections, wherein FIG. 2A-a shows an embodiment of a sampling bag with walls comprising metal alloys of a single sheet with welding a seam without margins; FIG. 2A-b shows an embodiment of a sampling bag comprising walls of metal alloys single sheet electric resistively welded seam with some protruded material; FIG. 2A-c shows one side of a sampling bag with hot laminated metal alloy sheet thermo-sealed plastic-to-plastic with additional strip over the seam; FIG. 2A-d shows an embodiment of the sampling bag with an outside surface thermo-laminated metal alloy sheet—thermo-sealed; FIG. 2A-e shows an embodiment of the sampling bag with two sides thermo-laminated metal alloy sheet on the inside with a fluorocarbon material and on the outside with additional material over the seam; FIG. 2A-f shows two sides of the metal alloy sheet having two plastic sheets with a thermo-seam; FIG. 2A-g shows an embodiment of the sampling bag comprising an outside laminated metal alloy sheet with fluorocarbon gasket protruded into the seam; FIG. 2A-h shows an embodiment of a sampling bag comprising a metal-to-metal seam by overlapping material and folding one sheet over another and hot lamination after sealing;

FIG. 2B including FIG. 2B-a and 2B-b depict cross sections of two embodiments of the sampling bag wherein FIG. 2B-a shows design comprising two (or more) interconnected fluidly chambers and FIG. 2B-b depicts a bag comprising walls having concentric corrugation of the surfaces of both walls congruently engaged when bag is empty;

FIG. 3 shows an embodiment of a sampling bag comprising walls comprising sheets of metal alloys with side panels, the side panels comprising rigid panels with retractable handles overlapping the perimeter of the bag and partial panels with soft handles, FIG. 3-a shows a perspective view of the bag with handles, FIG. 3-b shows a perspective view with the handles engaged;

FIG. 4 shows an embodiment of the sampling bag comprising walls having sheets of metal alloys bag with side panels and strip-formed handles, FIG. 4-a shows the handles engaged—initial position; FIG. 4-b shows the handles pulled out and the sampling bag filled;

FIG. 5 shows a perspective view of sampling bag filled with a sample with closed inlet 27 ready for mailing or analysis; FIG. 5-a shows a sampling bag with overlapping panels and precut handles; FIG. 5-b shows a sampling bag with small panels (less than the size of the walls) and soft handles;

FIG. 6 shows a perspective view of a sampling bag with walls comprising flexible sheets of metal alloys (metal alloys bag) with side panels pushed out by springs for self sampling and with sampling head having either a selectable inlets with aerodynamic resistances or septum;

FIG. 7 shows a sampling valve with basic multifunctional sampling head having: On/Off function and sampling attachments wherein the sampling attachments may include a sampling tubes with selectable aerodynamic resistances; a septum; selectable aerodynamic resistances mounted on rotatably and fluidly interconnected turret, ready to sample by calibrated capillary mounted on the rotating turret;

FIG. 8-A shows an embodiment of a sampling head or sampling valve capable of being opened by rotating the stem 90° to Off position and back 90° to the Open position, a capillary on the turret disconnected fluidly and quick connection socket connected to semi-hard tubing; FIG. 8-B shows an embodiment of the sampling head or sampling valve rotated 90° to “Off” position, capillary on the turret disconnected fluidly and barbed tube connector inserted into a quick connection socket; and

FIG. 9 shows an embodiment of a sampling bag comprising a quick disconnect coupling wherein the quick disconnect coupling is attached to a flow nozzle comprising a calibrated aerodynamic resistance for customizing the sampling time.

### DETAILED DESCRIPTION OF THE DRAWINGS

The invention is directed to improvements in containers with flexible walls and sampling bags. The invention is directed to a sampling bag for holding laboratory standards, industrial hygiene samplings or other gases or liquids. In one embodiment, the sampling bag comprises at least one flexible wall. Sampling bags with flexible walls may be inflated or deflated to increase or decrease the internal volume of the sampling bag. Embodiments of the sampling bags comprise at least one flexible wall comprising at least one layer comprising a metal alloy. In certain embodiments, the metal alloy in a thin sheet of metal alloy on the inner layer of the wall of the sampling bag. The layer comprising the metal alloy may be a metal alloy sheet.

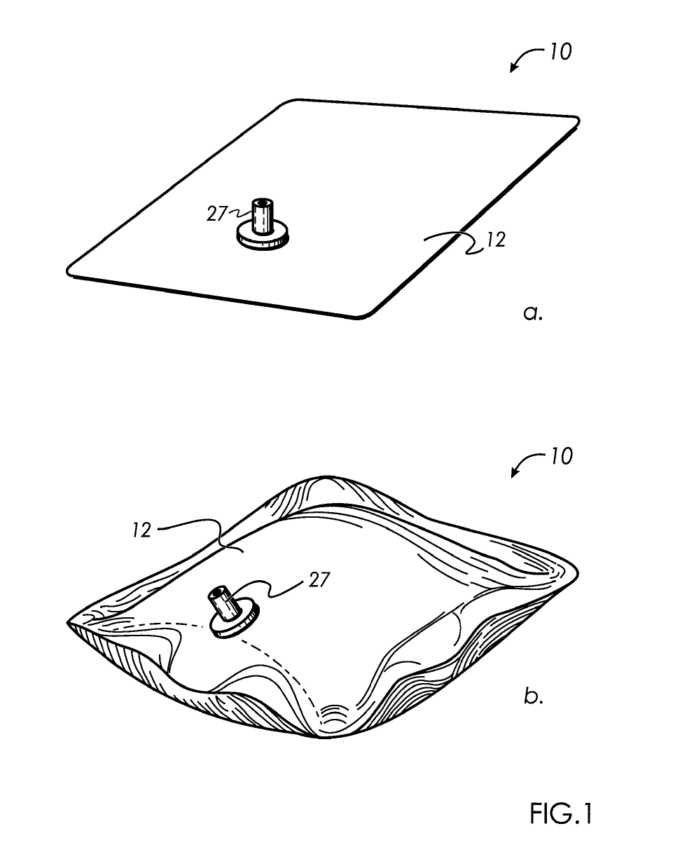

As shown in FIGS. 1a and 1b, a typical embodiment of the sampling bag will comprise two flexible walls wherein each flexible wall comprises at least one layer of a metal alloy sheet. An embodiment of a sampling bag comprises an enclosure comprising at least one flexible wall and an inlet, wherein the flexible wall comprises at least one layer of a metal alloy sheet. The flexible walls comprising a metal alloy allows the sampling bag to have a changeable volume similar to sampling bags with plastic walls and the layer comprising or consisting of a metal alloy provides the sampling bag with the low permeability and absorption of a fixed volume metal container. Embodiments of the sampling bag may comprise or consist of two flexible walls, wherein each flexible wall comprises at least one layer comprising or consisting of a metal alloy sheet. In such embodiments, the two flexible walls may be joined directly or indirectly together to form the sampling bag. In such embodiments, both sides of the sampling bag may be expanded to increase the volume of the sampling bag and then compressed to reduce the volume back to substantially zero to expel a substantial portion of the gas within the expanded sampling bag. In this manner, the sampling bag may easily be purged and ready for use.

Metal alloy sheets may be used to form a layer of the flexible walls. The metal alloy sheet may be any shape including, but not limited to, rectangular, square, rectangular, oval, cylindrical, folded shapes such as accordion shapes or other folded shapes, or combination of shapes. Some shapes may be more advantageous for certain applications because the shape may be more conducive to compression of the sampling bag to a minimum volume thus expulsion a substantial portion of the residual sample of a previous use of the sampling bag. The layer comprising the metal alloy wall may be flat, corrugated, fluted, folded, or otherwise configured to facilitate inflation and deflation.

The layer of metal alloy sheet may be any desired thickness that has the properties desired for a particular application. These properties include strength, flexibility, permeability, resilience, and other desired properties. In some embodiments, the layer of metal alloy may have a thickness within the range of 1 micron to 100 microns. In other embodiments, the layer of metal alloy may have a thickness within the range from 20 microns to 60 microns or from 25 microns to 50 microns. If desired, the flexible wall may comprise more than one metal alloy sheet of similar or different thicknesses that provide the combination of desired properties.

As used herein, “metal alloy” may be any metal including pure metals or combinations of different metals. The metal alloy may be any metal alloy that has the desired properties of strength, flexibility, resiliency, permeability and absorption. In some embodiments, the metal alloy may be, but is not limited to, stainless steel alloys such as SST 304, SST 309, SST 316, SST 316L, SST 321, low carbon stainless steels, nitinol, nickel, or titanium, for example. Other metal alloy with the desired properties may also be used in embodiments of the invention. For example, a layer of the flexible wall may consist essentially of a flat sheet of stainless steel or a corrugated sheet of stainless steel. The properties of the metal alloy sheet are sufficient if the sampling bag may be inflated and deflated at least one time.

Further, the sampling bag may comprise a panel adhered, attached, or otherwise connected to the flexible walls as described in pending patent applications entitled “Device for Fluid Sampling” and “Containers for Fluids with Composite Agile Walls” filed on Feb. 16, 2011 by the same inventors. A relatively simple to use embodiment of the sampling bag may comprise two flexible walls, wherein each wall comprises a panel attached to the out surface of the wall. The panels may comprise any material that is capable of being adhered to the wall and be pulled to inflate or compressed to deflate the sampling bag. For example, the panels may comprise a material selected from paper board, corrugated paper, or corrugated boards, for example. The sampling bag may further comprise springs capable of biasing the panels apart or toward each other to urge the sampling bag into an initial shape.

As seen on FIGS. 1a and 1b, an embodiment of the sampling bag 10 with metal alloy walls 12 is in a substantially rectangular shape. The corners of the bag, as shown, may be rounded or chamfered in order to avoid fluid residue in the corners. For certain embodiments of a rectangular sampling bag, the seam should be as close to the perimeter as possible to limit the amount of excessive material. The excess material beyond the seam may contribute to an undesired (in some applications) stiffness to the bag, reduction in flexibility or generation of stress points when sampling bag is loaded. Embodiments of the sampling bag 10 comprising metal alloy walls may have slightly less capacity compared to similarly sized sampling bags with plastic walls for the same sized wall sheets. The size of the metal alloy walls may be increased or decreased to adjust the inflated volume of the sampling bag.

As in other sampling bags, excessive side material and excessive inflation of a sampling bag may lead to side wall wrinkles. Wrinkles may create tension at localized points (stress point) in the seams and faster wear of the bag. One advantage of the sampling bag comprising flexible walls comprising a metal alloy 10 compared to the plastic bag is that metal alloy sheets have substantially no wall permeability and are capable of storing samples for a prolonged time. For example, samples may be stored several times longer than any plastic sampling bag. The bag from metal alloy may last tens of times longer than plastic walled sampling bags and contribute to remarkable overall efficiency. The bag has advantages compare to a solid wall canister by its weight, size, small volume, effortless use and low mailing costs. Embodiments of the sampling bags with metal alloy walls combine the advantages of plastic sampling bags and fixed volume metal containers without the disadvantages.

Further embodiments may include a method of forming a sampling bag. Embodiments of a method of forming a sampling bag may include at least one of the following steps, presented in no particular order. The thin metal alloy sheets of sample bag 10 walls 12 may be sealed by a variety of methods. The metal alloy walls of the sampling bag may be chemically polished, especially the inner side of the wall. The chemical polishing may be performed by any known method, such as treating the walls with a reagent based on mix of hydrochloric, nitric and hydroxybenzoic acids in presence of cationic surfactant and ferricyanide complex for 6 to 12 hrs. at 35 to 50° C., for example.

A further step may be chemical passivation of the inner side of the flexible wall. Chemical passivation may be performed by contacting at least the inner wall with 3% Citric acid at 50° C. for 2 hrs.

Further, another step may include cutting the sheets of the metal alloy sheets. For example, a method may include cutting two similarly sized rectangular pieces of the thin metal alloys for the walls. A combination of these steps may be used to form a very smooth thin and chemically stable layer on the inner surface of the metal alloy. A possible additional step comprises cutting an aperture in at least one of the metal alloy sheets. For example, one of the metal alloy sheets may be punched to form an aperture with dimension capable of accommodating a base of appropriate sampling head fixture 27 or other sampling valve or septum. The base of fixture 27 may be mounted in the aperture securely to assure gas tightness by using gaskets 11, for example. The base may be permanently installed using adhesives. A further additional step may include cutting one sheet of metal alloy, for example, with mounted fixture 27 such that it overlaps the other wall. Then both sheets may be sealed together such as by an adhesive, gaskets, mechanical clamping, laser welding, electric resistive welding around the perimeter in a seam, other sealing methods or a combination of sealing methods, for example. Seams on the edges of the sampling bags produced by the welding processes may be 0.5-1.5 mm wide, for example.

It may be desirable that the fixture 27 that may be removable from the sampling. For example, fixture 27 may comprise removable upper part which to provide access to the inside space of the sampling bag. A possible further step to produce a sampling bag may be passivating the inside area of the seams after the bag is formed by removing the fixture 27 and adding the passivation chemicals. Laser welding electric resistive welding or other heat associated sealing technique may result in colored oxides forming on the walls. The cleaning or passivation may be performed with nitric or citric acid solutions by adding the acid solution or substantially filling the bag to the top with the solution for the time necessary according to procedure for passivating. For example, passivation may be performed by a 3 to 10% acid solution in contact with the metal alloy for more than 2 hrs. The passivation time may depend on several factors including degree of oxidation of the seams during sealing or other process. After seam passivation, the bag may be dried to remove residue. Drying of the interior space of the sampling bag may be performed by conventional means, such as performed by and heating the bag in a vacuum oven at elevated to 100° C. temperature or any other means. The top part of fixture 27 may be replaced if it was removed or not yet installed in any previous step.

Further, the sampling bag may be tested for leaks. Leaks may be present in the seam and around gasket 11. Leak testing may be performed by any known method such as, but not limited to, a foam-bubble method or pressure test. In certain embodiments, the sampling inlet 27 may be manufactured from material that are stable at high temperatures, such as fluorocarbons like PTFE, FEP, Delrin™ (acetal), PTFE filled Delrin-AF™, and the like or from a metal alloy such as titanium or stainless steel. All components exposed to the inner volume of the sampling bag be made of the same material or material having the similar properties, such as permeability, composition and/or absorption properties. For example, a metal valve in a sampling bag will not be adversely affected if the bag assembly 10 is dried or purged with high temperature ˜200° C. pure nitrogen or pure air. Similar temperatures may be applied to purge and vacuum the laser sealed bag after being used.

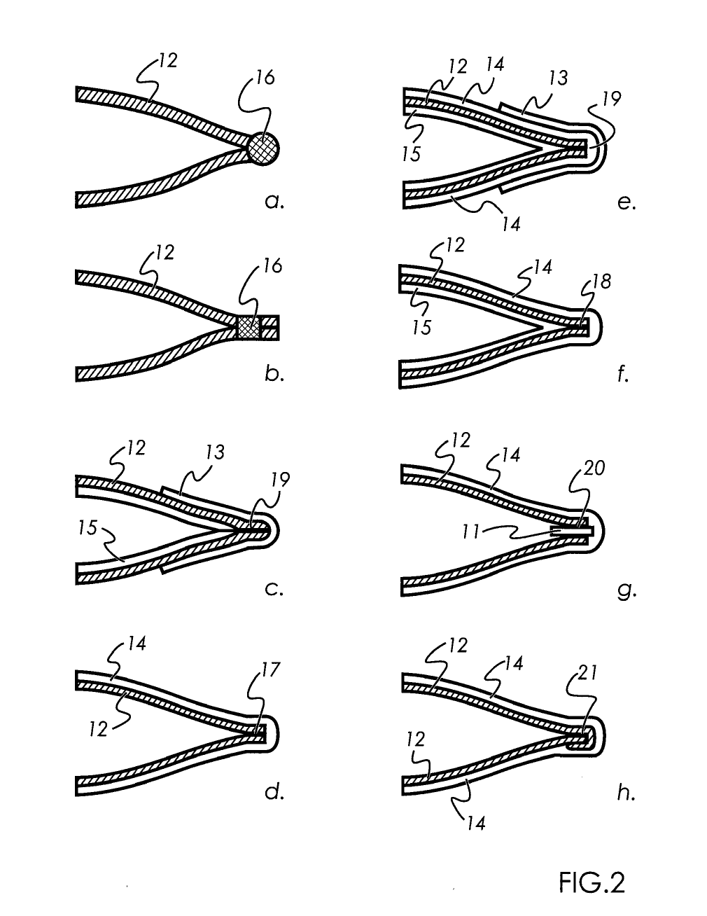

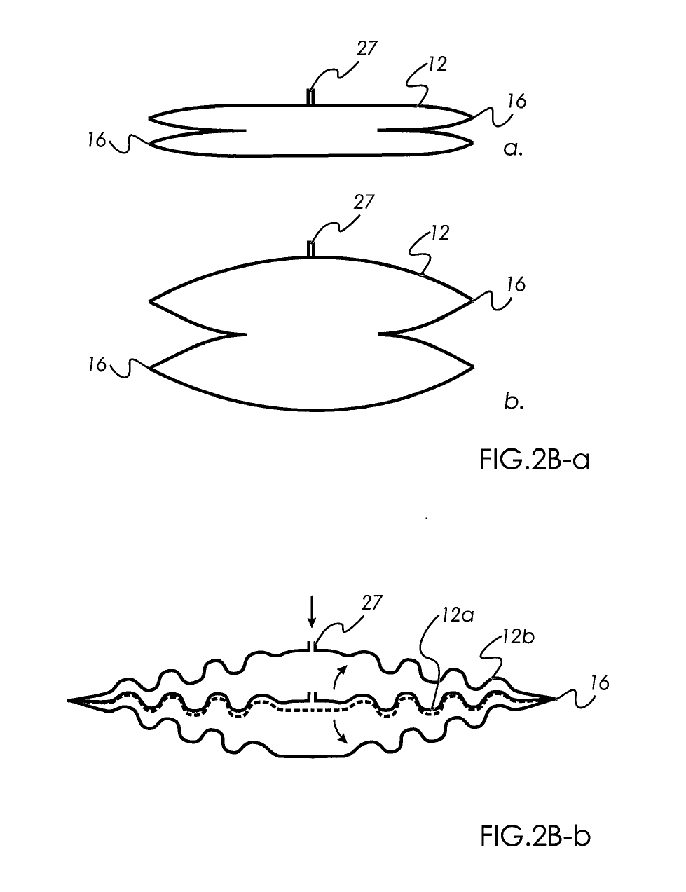

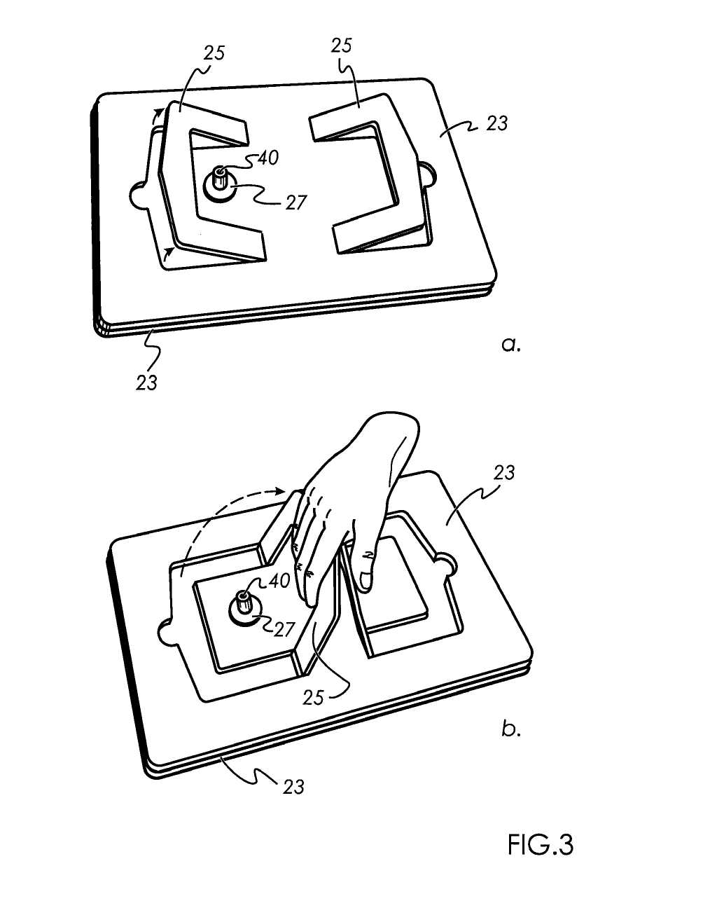

A cross-section of the seam on an embodiment of the sampling bag is shown on FIG. 2A-a. The sampling bag 10 made only from metal alloy sheet walls 12 can have sharp edges including corners and sharp edges along the wall seams. For that reason, to assure safety properties or for other reasons, the material of the walls may be laminated outside with a plastic layer or partial layer. The plastic material may have charge dissipating properties. This process may include cold lamination using silicon adhesive laminate or hot lamination using appropriate materials. In certain embodiments, the laminating material may have comparably high thermal stability to thereby withstand relatively high temperatures in case of purging the inside volume from some volatile organic compounds (VOC) with higher boiling points, such as, for example, the plastic material is thermally stable at and above 100° C.

In embodiments with cold lamination materials such as thin vinyl with strong acrylic adhesive may be used if sampling of high boiling points VOC is not expected. More preferable are fluorocarbons as thin 1 to 4 mil sheets laminated with silicon based adhesives because bag laminated this way can be thermally treated up to 200° C. without losing any sealing properties of those used with other plastics or adhesives. The fluorocarbons and silicon adhesive do not outgas which may be another important feature such that they do not contaminate the sampled fluid by outgasing. The laminate may protrude by 6-12 mm beyond the metal alloy sheets to assure good adhesion between the two surfaces. As the protruded margins will be flexible and may not contribute to forming wrinkles. The cross-section of such seam is shown on FIG. 2A-b.

Another way to manufacture bags is from metal alloys thin sheet preliminary cleaned and passivated then laminated from one or two sides. The processes are different when one side is laminated. If one side is laminated, the laminating material may protrude 8-15 mm out from each side. In such embodiments, the metal alloy sheets should overlap which is easy controllable by observing through transparent or translucent laminating material or by mechanical means.

An additional step that may be added to the method of forming a sampling bag may include thermo-sealing the walls of the sample bag. The inner side of embodiments of the sampling bag may comprise or consist of a metal alloy sheet 12, the external side may be a plastic laminate 14 as shown in FIG. 2A-d. In such a step, the jaws of thermo-sealing tool may overlap part of the metal alloys material and protrude out to heat seal the plastic. After the thermo-sealing the seam cross-section may look as shown in FIG. 2A-c. In such an embodiment without the direct sealing of the metal alloy sheets, the fluid in fully loaded bag may contact the area of the plastic material in the seam. The contact surface on the inside of the sampling bag of the plastic material of the outer laminate is relatively small compared to the surface area of the metal alloy wall. As such, any diffusion of the fluid component through the laminate is very unlikely because of the distance between inside contact and outside environment through the laminate. The thickness of such seam can be increased by adding strips from the same or thicker material over the edges of walls on the seam area as shown on FIG. 2A-d. This type of seam is inexpensive and further supports the seam from damage by overpressuring.

Further embodiments of sampling bags, such as embodiments for use in sampling of aggressive sulfur containing compounds, the inside of the seam of the bag may be also laminated by a fluorocarbon layer 14. In some embodiments, this lamination 14 may be done such that the laminate extends 0.5-1 mm over the edges of the metal alloys sheets 12 and then the external surface is thermo-laminated or sealed by other means 13. The cross-section of such seam assembly is shown on FIG. 2A-e. In some embodiments, the plastic material extends beyond the sheets and is thermo sealed. A layer added to the inside of the metal alloy wall may comprise other plastic materials also. The inner layer may be inert to the sampled component but somewhat permeable, in such an embodiment the metal alloy wall provides impermeability to the composite wall.

To avoid exposure of the walls edges 18 (not specially treated) when the walls 12 inside are not laminated as described, a gasket strip, such as a fluorocarbon gasket, may be introduced in the seam as shown on the FIG. 2A-f. The bags comprising fluorocarbons with cold seam comprising silicon adhesive may withstand temperatures up to 180-200° C. Other embodiments may be heated to 80° C. without lose of properties. These temperatures may be reached when the bag is heated and vacuumed for purging and cleaning, for example, or for hot gas sampling.

Another means for sealing the metal alloys sheets to form a bag is to mechanically seal the bag, for example, by folding the metal alloy sheets 12 one or two times to form a seam 21. Silicon adhesive may be introduced in folded area before folding. Folded seams are shown in FIG. 2A-h and may be more rigid and inflexible than other sealing methods due to the multiple layers of metal alloy. The rigidity may lead to wrinkles across the side seams and walls and some tension in the corner points upon inflation. These embodiments may also include additional layers 14.

To avoid deep wrinkles in the flexible walls which may lead to material fatigue at the stress points formed at the end of wrinkles. As already mentioned, the metal alloy bag should be filled with a volume less than plastic one with the same outer dimensions. Having a bag with two or more interconnected chambers, as shown on FIG. 2B-a, is a preferable way to avoid deep wrinkles. The cross-section of the embodiment in FIG. 2B-a is shown at low inflated and fully inflated volumes in order to make visible walls which in flattened bags are very close and inseparable for observation.

Another embodiment is depicted on FIG. 2B-b wherein both walls of the sampling bag are corrugated with grooves and ridges in substantially concentric circles. Such corrugation allows the walls to be “stretched” far beyond the position allowable to flat wall shown on FIG. 1 yet not forming wrinkles. In the flattened bag the walls are congruently engaged and one wall is shown with dashed lines. It may be seen in the FIG. 2B that after stretching the groves and ridges are becoming less deep and the sinusoidal surface Is stretched—longer than initial one shown in the middle of FIG. 2B-b. Corrugation can be performed by rolling ducting or press-formation, for example.

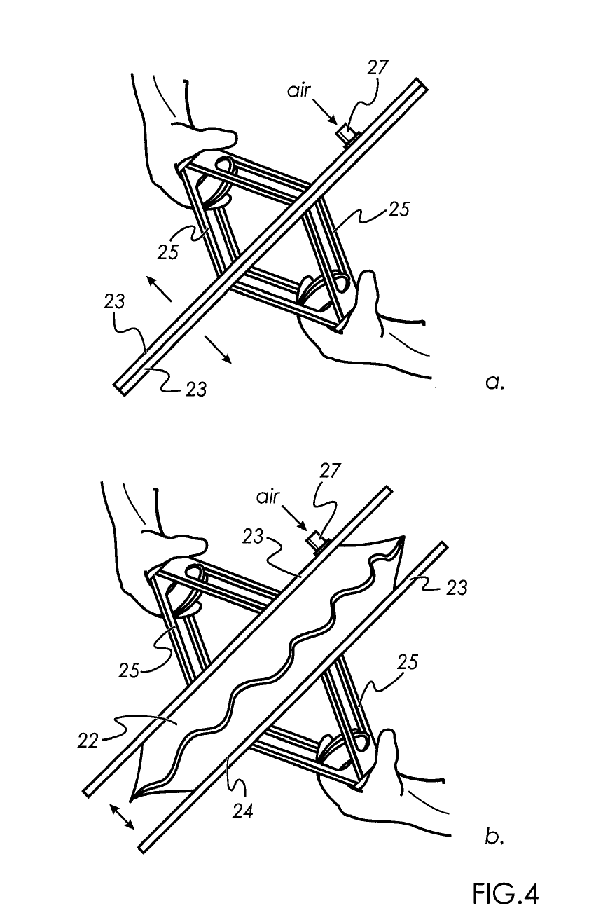

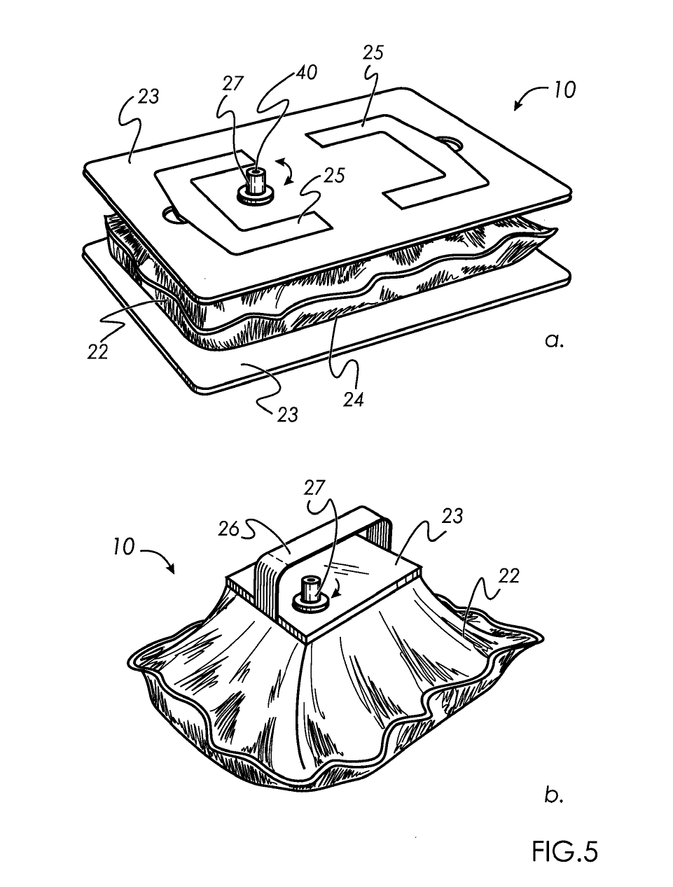

There are a variety of embodiments of the sampling bags and only a few are shown. It may be seen that the manufacture, assembly and designs having slightly different properties easily adjusted to the sampling needs. Any of the embodiments of the sampling bag with flexible walls, including both metal allow sheets and/or plastic laminates, may additionally comprise panels 23 capable of assisting in use of the sampling bag. As shown in FIG. 3, the panels may comprise handles, the handles 25 may be retractable, precut partially from the same material of panels as shown on FIG. 3-a and engaged by hands or other mechanism as shown on FIG. 3-b, FIG. 4-a and FIG. 4-b. Materials such as, but not limited to, paper board, corrugated paper or plastic boards are suitable for side panels. FIG. 4 shows a process of expanding and filling the sampling bag by simply pulling out both side panels of the bag. This kind of sampling is extremely advantageous compare to any other pump method especially for grab sampling. The bag can be filled and purged several consecutive times to allow dynamic equilibrium of the sampled fluid mixture on the bags walls. Such procedure cannot be easily performed with any existing sampling bags or methods of sampling. The contamination and loses contributed by tubing and the pumps is significantly reduced. The recovery may be close to 100% compare to 85-90% with conventional pump-bag combination systems. The sample concentrations are stable orders of times longer as compared to samples stored in plastic bags. On FIG. 5-a is shown a bag with side panels 23 overlapping bag's walls after filling. On FIG. 5-b is shown a bag with side panels 23 smaller than the size of bag's walls having a foldable handles 26 made from strips of other soft material—fabric, mesh, plastic tape etc. attached to the side panels 23.

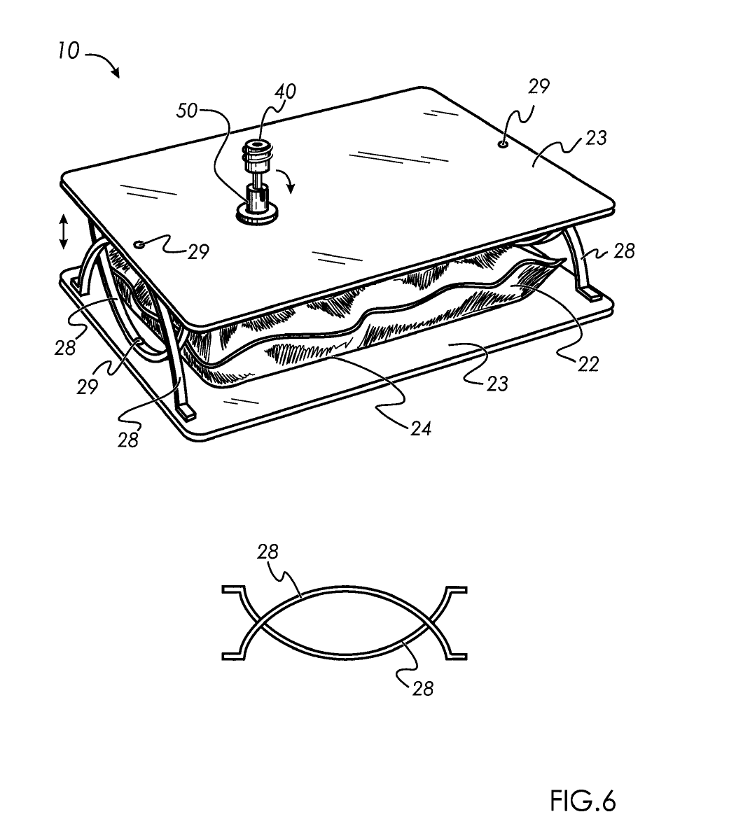

Another embodiment of a sampling bag comprising flexible walls is shown on FIG. 6. The side panels 23 are made from a stiff rigid material. Materials such as stiff acrylic, polypropylene, ABC or polycarbonate sheet are appropriate for side walls in the embodiment shown in FIG. 6. The side panels 23 may be biased away from each other by springs 28 positioned between the panels 23. Expansion of the sampling bag from a flat empty position creates underpressure within the sampling bag 22 which creates a driving force for fluid to enter the bag. The springs may be selected from a group including flat springs (as shown), waved springs 28, crest-to-crest springs or spiral or coil springs. The most preferable for several embodiments may be flat springs and crest-to-crest springs chosen because of their small initial height compare to the height of expanded spring which allow the side panels 23 to be positioned in very close proximity when bag 22 is empty with simply designed panels. The advantage of the design shown on FIG. 6 is that the sampling bag may be use to perform a self-sampling process. Self sampling provides convenience for long term sampling without pumps. To perform long term self-sampling, a consistent low flow should be attained over the sampling period.

Embodiments of sampling bags may further comprise a multifunctional inlet valve. The valve may comprise different features including an inlet with a simple shut off valve and an inlet with a restricted flow rate. The simple shut off valve has on/off capability and is used primarily for grab samples. Grab samples may typically be used to obtain “instantaneous” samples for industrial hygiene environmental samples. The samples are then analyzed in a laboratory to determine the concentration of various constituents present at the time of sampling. The inlet with a restricted flow rate may be used to obtain samples over a sampling period. The samples may then be analyzed in a laboratory to determine the average concentration of various constituents over the sampling period. The sampling period may be any desired period of time such as, but not limited to, fifteen minutes, thirty minutes, one hour, four hours, or eight hours, for example.

In general, an embodiment of the sample valve may be used with a new sampling approach in accordance with fast grab sampling and/or sampling within extended time period. Conventional sampling valves cannot perform all of these functions. Conventional valves are simple shut-off valves convenient mainly for grab-sampling. Completely new sampling inlet/outlet flow regulating fixture must be designed to accomplish all necessary requirements.

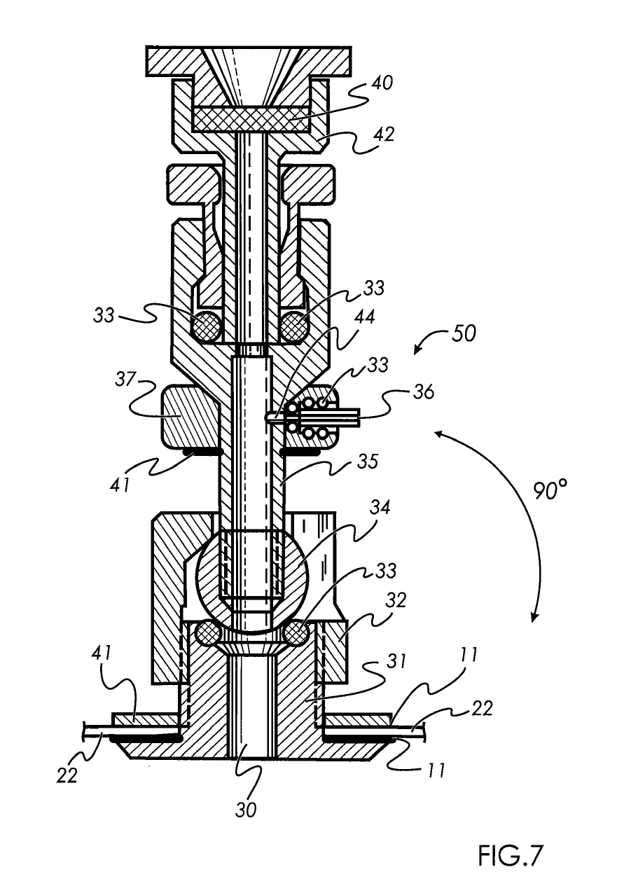

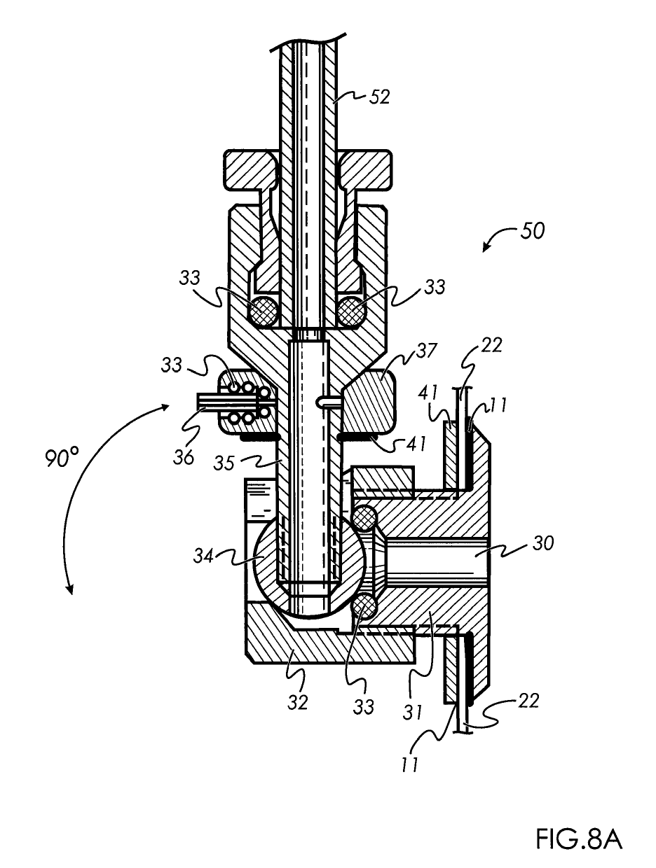

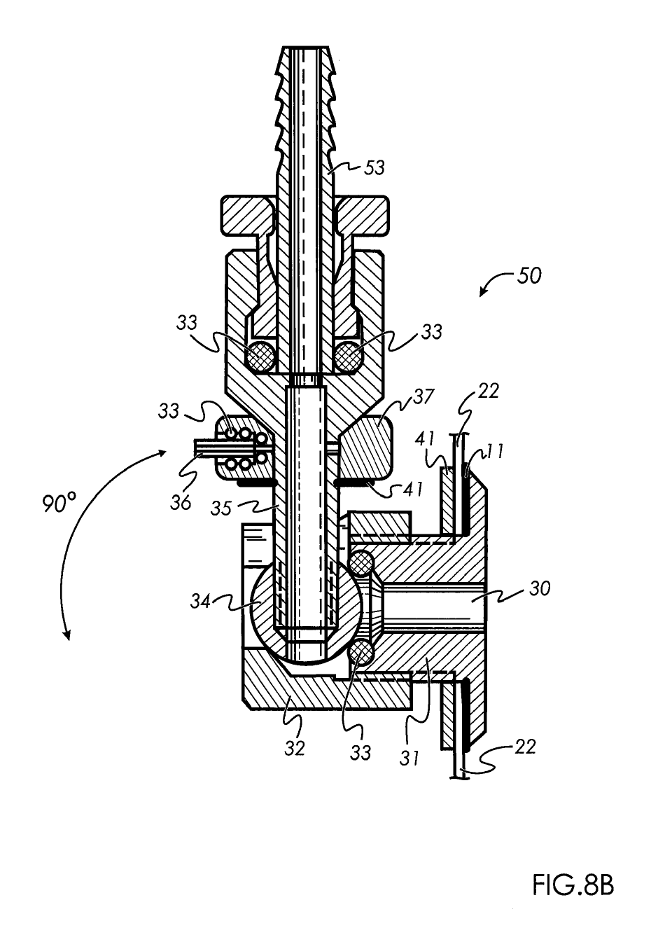

Embodiments of the sampling valve or sampling head 50 is shown on FIGS. 7, 8-A, 8-B and 9. The sampling head 50 has several different features and functions.

The embodiment shown in FIGS. 7 and 8 comprises an on/off control valve and may be opened (on) and closed (off) by pivoting the stem 35, wherein the valve is open when a longitudinal axis of the stem is oriented parallel to a longitudinal axis of the base and the valve is closed when the longitudinal axis of the stem is oriented perpendicular to a longitudinal axis of the base. Of course, the operation could be reversed, wherein the wherein valve is open when a longitudinal axis of the stem is oriented perpendicular to a longitudinal axis of the base and the valve is closed when the longitudinal axis of the stem is oriented parallel to a longitudinal axis of the base. The sample valve or sample head may be used for grab samples or connected to other sampling devices such as tubing and pumps by connection to the stem or an intermediate part such as tube connector 52, barbed tube connector 53, or other connector or inlet device. Typically, the connectors and other parts may be sealed with gaskets 33.

Embodiments of the sample valve or sample head 50 may comprise an inlet having a calibrated aerodynamic resistance 36. The inlet having a calibrated aerodynamic resistance 36 is designed to have a consistent flow rate over a period of time. The inlet having a calibrated aerodynamic resistance 36 is designed to maintain a flow rate within a specified flow range over the desired time even with some pressure fluctuations. The inlet having a calibrated aerodynamic resistance 36 may be used for taking samples over extended sampling periods. Embodiments of the sample valves or sample heads may have more than one inlet having a calibrated aerodynamic resistance 36. The inlets may be calibrated for different sampling periods to easily accommodate different sampling procedures and operations with the same sample bag.

Embodiments of the sample valve or sample head may comprise a quick connection on the stem 35. The quick connection may be used to add various attachments to the sample valve or sample head 50. Such attachments may include, but are not limited to, a fixture with a septum 40 for syringe/needle transfer or fluid sample; a tubing connector 52 for fluid transfer; a barbed tubing connector 53 for fluid transfer; an inlet having aerodynamic resistance 39 designed for a specific sampling period and/or flow rate. The sampling period and/or flow rate may be adjusted by changing the length and/or diameter of the flow path of the inlet 39, for example.

The use of sampling head 50 can involve several steps depending on the type of sampling—grab sampling or extended period sampling. For grab sampling, the sampling bag may be flattened by pushing the walls by hand, by machine or with a weighted object, for example. The bag's sample valve or sample head may be opened, for example, as shown on FIG. 7 to empty the sample. The sample bag may also be connected to a vacuum source to empty the bag. This may be performed by attaching to the fast connection socket 42 semi-hard tubing 52 or barbed tube connector 53 (seen in FIGS. 8-A, 8-B). The vacuum pump may be a syringe, pocket pump, or other vacuum source, not shown on figures. Then the sampling head 50 is pivoted along a 90° angle to perpendicular position shown on FIG. 8A (the septum assembly 42 is not introduced). When the sampling head 50 is folded again to the parallel position as on FIG. 7 the septum assembly 42 may be removed and the sampling is performed simply by fast intake flow. The operation may be repeated several times to ensure wall saturation of the targeted constituents and better sample recovery. After the bag 22 of assembly 10 is shown containing a sample, the sampling head may be again pivoted through a 90° angle and a sampling septum assembly 42 may be connected to the stem 35. The bag assembly is ready for shipment and/or sampling. Further, a sample for laboratory analysis may be withdrawn via septum 40 when again the ball valve 34 is opened as on FIG. 7. Alternatively, a sample may be taken also by replacing assembly 42 by semi-hard connection tube 52 for fluid transfer as shown on FIG. 8-A. In many embodiments, all operations can be performed within one minute. The bal valve on/off function may be performed with only one hand only immediate after the sampling is finished, if desired. One hand operation of the valve is advantageous for grab sampling when two hands are used to open the bag assembly performed as shown on FIG. 4.

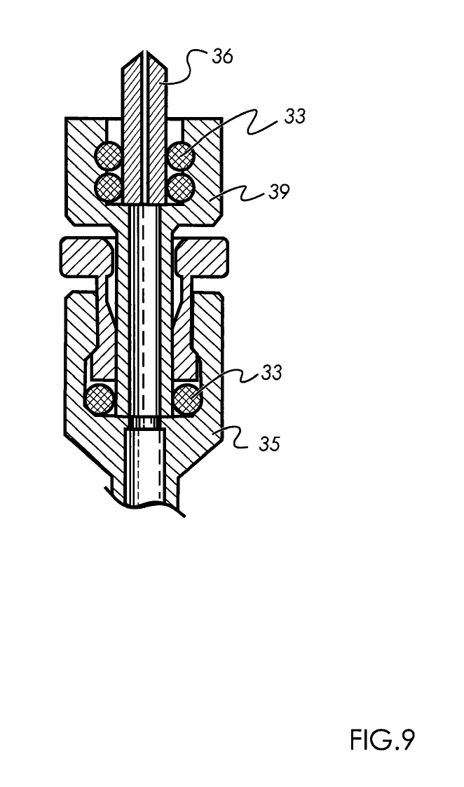

For long term sampling the bag 10 is in starting position, shown on FIG. 7 the turret socket 37 is set in position when the aperture 44 on the stem socket 35 is aligned with the aerodynamic resistance 36 (micro-capillary shown on the FIG. 7 and FIG. 8). The socket on the stem 35 is fitted with septum assembly 42 and the flow is possible only through the aerodynamic resistance 36. The resistance 36 is calibrated for long term sampling for one of the standardized sampling times: 15 min, 30 min, and 1 hr, 2 hrs, 4 hrs, 8 hrs, 24 hrs (or other desired time). After the sampling time is expired the turret is turned to angle where the aerodynamic resistance is not in fluid connection with aperture 44, sampling head 50 is bended at 90° angle and the bag assembly 10 is ready for shipment or immediate analyses. Further the septum assembly 42 is used for syringe/needle sample withdraw or septum can be replaced by semi-hard tube connector for fluid transfer as desired. The assembly 42 may be also replaced by any aerodynamic resistances in socket 39 for their customization and calibration as shown on FIG. 9.

### FEATURES

The present invention is suggesting embodiments of a novel type sampling or self sampling bag with original type of sampling inlet—sampling head. Both of the novelties resulting in many new features compare to all existing art of sampling with bags or canisters:
No pumps of any type to expel or to fill fluids into container
No battery charging and maintenance
No pump calibration
Extreme ease of changing the sampling mode—grab sampling/long term sampling for several predetermined sampling times by multifunctional sampling head
Extreme simplicity of operation—no needs for special qualification
Inexpensive sampling process—low cost of use
One person can run several parallel sampling devices or consecutive sampling operations. Extreme effectiveness of the labor force
Major modes set on sampling head are operated by one hand only
Low cost of manufacturing
Higher recovery in case of grab sampling—close to 100%
Substantially no sorption on the walls of external lines or inside pumps
Substantially no cross-contamination
All directly sampled volume is usable
Always ready for sampling
When empty with closed inlet, many containers can fit in relatively small volume (portability is extremely important for field sampling)
When loaded the devices are portable and easy to mail
The devices are intrinsically safety and provides intrinsically safety sampling.

The embodiments of the described methods and sampling bags with agile walls are not limited to the particular embodiments, method steps, and materials disclosed herein as such formulations, process steps, and materials may vary somewhat. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

1. A sampling bag, comprising:
at least one flexible wall, wherein the flexible wall comprises at least one layer comprising a metal alloy; and
an inlet.

2. The sampling bag of claim 1, wherein the flexible wall comprises at least one layer comprising a metal alloy sheet.

3. The sampling bag of claim 1, comprising two flexible walls comprising at least one layer of a metal alloy sheet.

4. The sampling bag of claim 3, wherein the two flexible walls are joined to form the sampling bag.

5. The sampling bag of claim 1, wherein the sheets have a thickness in a range from 25 microns to 50 microns.

6. The sampling bag of claim 1, wherein the layer consists essentially of a flat sheet of a stainless steel.

7. The sampling bag of claim 1, wherein the layer consists essentially of a corrugated sheet of a stainless steel.

8. The sampling bag of claim 1, wherein the metal alloy is selected from a group comprising stainless steel alloys such as SST 304, SST 304, SST 309, SST 309L, SST 316, SST 316L, SST 321, SST 321 L, low carbon stainless steels, Nitinol, nickel, or titanium.

9. The sampling bag of claim 1, comprising at least one panel attached to the flexible wall.

10. The sampling bag of claim 3, comprising at least one panel attached to each of the flexible walls.

11. The sampling bag of claim 10, wherein the panels comprise a material selected from paper board, corrugated paper, or corrugated boards and a handle.

12. The sampling bag of claim 10, comprising springs capable of biasing the panels.

13. The sampling bag of claim 11, wherein the springs bias the panel away from each other or bias the panels toward each other.

14. The sampling bag of claim 1, comprising a valve on the inlet.

15. The sampling bag of claim 14, wherein the valve comprises a quick disconnect connector or multiple inlets comprising shaped orifices resulting in different flow characteristics under identical flow conditions.

16. A method of forming a sampling bag, comprising:
sealing the perimeter of at least two sheets of corrosive resistant metal alloy sheets to form the sampling bag; and
providing an inlet to access to the space between the two sheets.

17. The method of claim 16, wherein the sheet are 25 or 50 microns thick.

18. The method of claim 16, wherein sealing the perimeter of the two sheets comprises welding the perimeter of the two sheets.

19. The method of claim 18, wherein welding the perimeter of the two sheets comprises laser welding the perimeter of the two sheets.

20. The method of claim 16, wherein sealing the perimeter comprises forming a seam that is form 0.5 to 1.5 mm wide.

21. The method of 16, wherein providing an inlet comprises forming an aperture in at least one of the metal alloy sheets.

22. The method of claim 21, wherein forming an aperture comprises punching an aperture.

23. The method of claim 21, wherein forming an aperture comprises cutting an aperture.

24. The method of claim 23, wherein cutting an aperture comprises laser cutting an aperture.

25. The method of claim 16, further comprising mounting a valve in the aperture.

26. The method of claim 25, wherein the valve comprises a quick disconnect connector.

27. The method of claim 25, wherein the aperture is sealed by mounting the valve using gaskets.

28. The method of claim 16, wherein one of the sheets overlaps the other sheet.

29. The method of claim 16, comprising passivating the space between the two sheets.

30. The method of claim 29, wherein the passivating the space between the two sheets comprising adding an acid to the sampling bag.

31. The method of claim 29, wherein passivating the space between the two sheets comprising filling the bag with an acid.

32. The method of claim 30, wherein the acid is nitric acid or citric acid.

33. The method of claim 30, wherein the concentration of the acid is from 3% to 5%.

34. The method of claim 29, comprising drying the interior of the bag.

35. The method of claim 34, wherein drying the interior of the bag comprises heating the bag under vacuum to a temperature above 60° C.

36. The method of claim 16, comprising chemical polishing of at least one side of each of the two sheets of corrosive resistant metal alloy sheets.

37. The method of claim 36, wherein chemical polishing comprises treating the walls with a reagent comprising a mix of hydrochloric, nitric and hydroxybenzoic acids in presence of cationic surfactant and ferricyanide complex for 6 to 12 hours in the temperature range of 35° C. to 50° C.

38. The method of claim 16, comprising chemical passivating at least one surface on each of the sheets prior to sealing the perimeter.

39. The method of claim 38, wherein chemical passivating comprises treating the surface with 3% citric acid at 50° C. for about 2 hours.

40. The method of claim 24, wherein the valve comprises at least one material selected from group comprising PTFE, FEP, Delrin, acetal, or from stainless steel.

41. The method of claim 39, wherein the stainless steel of the valve is the same material as the sheets.

42. The method of claim 16, comprising laminating an outside surface of the walls with a plastic material.

43. The method of claim 17, wherein the plastic material has charge dissipating properties.

44. The method of claim 41, wherein the plastic material has a high thermal stability.

45. The method of claim 44, wherein the plastic material is thermally stable at 100° C.

46. The method of claim 42, wherein the plastic material is a vinyl material laminated with an acrylic adhesive or a fluorocarbon with silicon based adhesive.

47. The method of claim 42, wherein the plastic material is laminated prior to sealing the perimeter.

48. The method of claim 47, wherein the plastic material extends beyond the sheets and is thermo sealed.

49. The method of claim 48, comprising an inner sealing material on the inside of the plastic sheets around the perimeter.

50. The method of claim 49, wherein the inner sealing material is a fluorocarbon.

51. The method of claim 16, comprising folding the perimeter.

52. The method of claim 50, comprising folding the perimeter twice.

53. The method of claim 16, comprising attaching panels to an exterior surface of the walls.

54. The method of claim 53, wherein the panels comprise handles.

55. The method of claim 54, wherein the panels comprise semi-hard flexible materials.

56. The method of claim 54, wherein the panels comprise a material selected from paper board, corrugated paper, or corrugated boards.

57. A sampling valve for a sample container, comprising
a base; and
a stem comprising a connector, wherein valve is open when a longitudinal axis of the stem is oriented parallel to a longitudinal axis of the base and the valve is closed when the longitudinal axis of the stem is oriented perpendicular to a longitudinal axis of the base.

58. The sampling valve of claim 57, wherein the stem comprises a quick disconnect connector capable of receiving a plurality of sampling attachments.

59. The sampling valve of claim 58, wherein the sampling attachments include a tube connector, a septum holder, or an inlet comprising a calibrated aerodynamic resistance.

60. The sampling valve of claim 59, wherein the inlet is calibrated to at least partially fill the sampling bag in a time selected from 15 minutes, 30 minutes, one hour, two hours, four hours, eight hours, or twenty four hours.

61. A sampling valve, comprising a multipositional valve, wherein the multipositional valve comprises at least two inlets and a three position valve.

62. The sampling valve of claim 61, wherein the each of the inlets is a calibrated aerodynamic resistance flow path.

63. The sampling valve of claim 62, wherein each of the inlets is calibrated for a different flow rate under identical conditions.

64. The sampling valve of claim 61, comprising three interchangeable inlets, wherein each of the inlets is calibrated for a different flow rate under identical conditions.

65. The sampling valve of any of claim 61, comprising a turret for selectively opening the valve to one of the inlets or for closing the valve.

66. The sampling valve of claim 61, wherein the sampling valve comprises a second valve, wherein the second valve is an on/off valve having two positions, wherein one position opens the valve and the second position closes the valve.

67. The sampling valve of claim 66, wherein the second valve comprises a base and a stem, wherein the second valve is open when the longitudinal axis of the stem is oriented parallel to a longitudinal axis of the base and the valve is closed when the longitudinal axis of the stem is oriented perpendicular to a longitudinal axis of the base.
